(19) United States
(12) Patent Application Publication
(10) Pub. No.: US 2026/0316831 A1
(43) Pub. Date: Oct. 15, 2026

(54) APPARATUS AND METHOD FOR CONTROLLING AN ACTUATOR

(71) Applicant: JAGUAR LAND ROVER LIMITED, Whitley Coventry Warwickshire (GB)

(72) Inventors: Cristina MACHADO, Whitley Coventry Warwickshire (GB); Carlos GIORGIO BORT, Whitley Coventry Warwickshire (GB); Juan HERRERA, Whitley Coventry Warwickshire (GB)

(21) Appl. No.: 19/483,966

(22) PCT Filed: May 21, 2024
(86) PCT No.: PCT/EP2024/063985

§ 371 Date: Nov. 12, 2025

(30) Foreign Application Priority Data
May 22, 2023 (GB) 2307602.9

(51) Int. Cl. B62D 15/02

(52) U.S. Cl. CPC B62D 15/025

(57) ABSTRACT

The present disclosure is directed to a control system for controlling a steering actuator of a vehicle, the control system comprising controllers comprising and input means for receiving a driver control signal and autonomous trajectory data, processing means arranged to determine a change in driving state of the vehicle and, when the change occurs, determine a driver trajectory for the vehicle, determine an error input to a steering controller in dependence on the autonomous trajectory and the driver trajectory, determine a control input for the steering actuator of the vehicle in dependence on the error input, determine limits for a magnitude of the control input for the steering actuator in dependence on one or more parameters associated with the vehicle, to limit a force applied to the steering control and output means for outputting a signal indicative of the control input for the steering actuator.

### CROSS REFERENCE TO RELATED APPLICATIONS

The present application is a U.S. National Phase of International Application No. PCT/EP2024/063985 entitled “APPARATUS AND METHOD FOR CONTROLLING AN ACTUATOR,” and filed on May 21, 2024. International Application No. PCT/EP 2024/063985 claims priority to Great Britain Patent Application No. 2307602.9 filed on May 22, 2023. The entire contents of each of the above-listed applications are hereby incorporated by reference for all purposes.

### TECHNICAL FIELD

The present disclosure relates to an apparatus and method for controlling an actuator. In particular, the present disclosure relates to an apparatus and method for controlling a steering actuator of a vehicle. Aspects of the invention relate to a control system, to a system, to a vehicle, to a method, to computer software and a computer readable medium.

### BACKGROUND

It is known for vehicles to have an autonomous driving functionality which allows at least some aspects of a driving task, such as steering the vehicle, to be at least semi-autonomously performed. The autonomous driving functionality may be at least level 3 autonomy as defined by The Society of Automotive Engineers (SAE). Such vehicles may be capable of environmental detection i.e. detecting objects in the environment to determine a control input for the vehicle, such as the steering input to the vehicle. However, a human driver is able to override autonomous control inputs provided to the vehicle such as by actuating a steering control of the vehicle. In this situation, the driver may perceive the autonomously provided steering input in the form of a force, such as torque, provided by an actuator to the steering control. The force applied by the actuator may be in a different direction or have a different magnitude than the driver actuation. A handover process is therefore performed over a period of time to transfer control of the vehicle from the autonomous functionality to the driver whilst maintaining control of the vehicle. It will also be appreciated that the same process may be performed in reverse where the driver releases the steering control to transfer control of the vehicle from the driver to the autonomous functionality.

It is an aim of the present invention to address one or more of the disadvantages associated with the prior art.

### SUMMARY OF THE INVENTION

Aspects and embodiments of the invention provide a control system, a system, a vehicle, a method and computer software as claimed in the appended claims.

According to an aspect of the present invention there is provided a control system for controlling a steering actuator of a vehicle, the control system comprising one or more controllers, the control system comprising input means for receiving a driver control signal indicative of a driver steering input at a steering control of the vehicle, and autonomous trajectory data indicative of an autonomous trajectory for the vehicle, wherein the control system is arranged to determine, in dependence on the driver control signal, a driver trajectory for the vehicle, determine an input to a steering controller in dependence on the autonomous trajectory and the driver trajectory, determine a control input for the steering actuator of the vehicle in dependence on the input, determine one or more limits for a magnitude of the control input for the steering actuator to limit a force applied to the steering control, and output means for outputting a signal indicative of the control input for the steering actuator of the vehicle.

According to an aspect of the present invention there is provided a control system for controlling a steering actuator of a vehicle, the control system comprising one or more controllers, the control system comprising input means for receiving a driver control signal indicative of a driver steering input at a steering control of the vehicle, and autonomous trajectory data indicative of an autonomous trajectory for the vehicle, processing means arranged to determine, in dependence on the driver control signal, a change in driving state of the vehicle and, when the change in driving state occurs, to, determine, in dependence on the driver control signal, a driver trajectory for the vehicle, determine an error input to a steering controller in dependence on the autonomous trajectory and the driver trajectory, determine a control input for the steering actuator of the vehicle in dependence on the error input, determine one or more limits for a magnitude of the control input for the steering actuator in dependence on one or more parameters associated with the vehicle, to limit a force applied to the steering control, and output means for outputting a signal indicative of the control input for the steering actuator of the vehicle.

Advantageously the error input is generated based on both the autonomous driving trajectory and the driver trajectory to improve a transition there-between. Furthermore controlling the magnitude of the control input assists in dealing with disturbances and non-linearities, such as non-linearities of actuators, driver input, vehicle response etc.

The control system optionally comprises processing means and memory means. The processing means may be one or more electronic processing device or processor which operably executes computer-readable instructions. The memory means may be one or more memory device. The memory means is electrically coupled to the processing means. The memory means may be configured to store the computer-readable instructions. The processing means may be configured to access the memory means and execute the instructions stored thereon.

The input means for receiving the driver control signal may be an electrical input of the control system for receiving an electrical signal corresponding to the driver control signal. The output means for outputting the signal indicative of the control input for the steering actuator of the vehicle may be an electrical output of the control system for outputting an electrical signal corresponding to the control input for the steering actuator.

The control system may comprise one or more controllers collectively comprising at least one electronic processor having an electrical input for receiving an input signal; and at least one memory device electrically coupled to the at least one electronic processor and having instructions stored therein; and wherein the at least one electronic processor is configured to access the at least one memory device and execute the instructions thereon so as to receive the driver control signal indicative of the driver steering input at a steering control of the vehicle, and autonomous trajectory data indicative of an autonomous trajectory for the vehicle, determine, in dependence on the driver control signal, the change in driving state of the vehicle and, when the change in driving state occurs, to, determine, in dependence on the driver control signal, a driver trajectory for the vehicle, determine an error input to a steering controller in dependence on the autonomous trajectory and the driver trajectory, determine a control input for the steering actuator of the vehicle in dependence on the error input, determine one or more limits for a magnitude of the control input for the steering actuator in dependence on one or more parameters associated with the vehicle, to limit a force applied to the steering control, and to output a signal indicative of the control input for the steering actuator of the vehicle.

The change in driving state of the vehicle may be determined by a driver actuation manager.

The driver trajectory for the vehicle may be determined by a driver trajectory estimator.

The error input is optionally determined by a trajectory blending unit. The error input may be determined with respect to a current trajectory of the vehicle.

The control input may be determined by a steering controller. The steering controller may be a model predictive controller, MPC.

Optionally the one or more limits for the magnitude of the control input are determined by a limit determiner.

The system may comprise an arbitrator which is arranged to limit the force applied to the steering control in dependence on the one or more limits. The arbitrator is arranged to output an arbitrated signal indicative of the control input for the steering actuator of the vehicle.

Determining the driver trajectory for the vehicle optionally comprises receiving environment data indicative of an environment of the vehicle. The system may predict the driver trajectory in dependence on the environment data and the driver control signal. Advantageously predicting the driver trajectory improves the transition.

The predicted driver trajectory may be used in dependence on one or more conditions determined in dependence on the environment data. The one or more conditions may comprise one or more of the predicted trajectory being collision free, laying within a navigable area (roadway), and being feasible for the vehicle i.e. possible. Advantageously erroneously predicted trajectories are reduced or eliminated.

The prediction may be performed using a trained driver trajectory model. Advantageously the trained trajectory model is representative of the driver's trajectories. The driver trajectory model may be updated in dependence an actual driver trajectory.

The control system may be arranged to determine a combined trajectory in dependence on the autonomous trajectory and the predicted driver trajectory. Advantageously the autonomous driving trajectory and the predicted driver trajectory are blended together.

Determining the combined trajectory optionally comprises smoothing the combined trajectory. The smoothing may be performed by a filter e.g. zero-phase filter.

Determining the driver trajectory for the vehicle may comprise determining an actual driver trajectory for the vehicle in dependence on the driver control signal. Determining the driver trajectory for the vehicle may comprise determining a trajectory offset in dependence on the actual driver trajectory in dependence, at least in part, on the autonomous trajectory. Advantageously determining the trajectory offset improves application of one or more limits.

Determining the trajectory offset may comprise determining a predicted trajectory offset using a trained trajectory offset model, and determining a combined trajectory in dependence on the autonomous driving trajectory and the predicted trajectory offset.

Advantageously the trained trajectory offset model is representative of the driver's offsets.

The trajectory offset model may be updated in dependence on the driver trajectory.

The control system may be arranged to determine the trajectory offset between the combined trajectory and the actual driver trajectory. Advantageously the autonomous driving trajectory and the actual driver trajectory are blended together.

The control system may be arranged to determine the trajectory offset between the control input for the steering actuator of the vehicle and a corresponding input associated with the actual driver trajectory. Advantageously the trajectory offset can be used when autonomous trajectory data is not available, such as depending on access to an autonomous trajectory planning system.

The error input to the steering controller may be determined in dependence on one or more parameters associated with the autonomous driving trajectory and the driver trajectory. The one or more parameters may be lateral speed and acceleration.

The one or more parameters associated with the vehicle on which the one or more limits for the magnitude of the control input are determined may comprise one or more of a speed, a yaw rate, a lateral acceleration, and jerk of the vehicle. Advantageously the magnitude is limited depending on the vehicle's current situation etc.

The one or more parameters optionally comprise a horizon for determining the control input for the vehicle.

The steering control of the vehicle may be a steering wheel. The control input for the steering actuator may be a steering control input. The steering control input may comprise one or both of wheel angle and torque. The wheel angle may be a road wheel angle, RWA.

The magnitude limit of the control input comprises one or both of a minimum and maximum torque applied to the steering control.

According to an aspect of the present invention there is provided a system, comprising a control system according to any preceding claim, and an actuator responsive to the signal indicative of the control input for the vehicle.

According to an aspect of the present invention there is provided a vehicle comprising a control system according to any of the above aspects or a system according to the above aspect.

According to an aspect of the present invention there is provided a method, comprising receiving a driver control signal indicative of a driver input at a control of a vehicle, receiving autonomous trajectory data indicative of an autonomous driving trajectory for the vehicle, determining, in dependence on the driver control signal, a change in driving state of the vehicle, determining, in dependence on the driver control signal, a driver trajectory for the vehicle, determining an error input to a controller for determining a control input for the vehicle in dependence on the autonomous driving trajectory and the driver trajectory, determining one or more limits for a magnitude of the control input at the control in dependence on one or more parameters associated with the vehicle, and outputting a signal indicative of the control input for the vehicle to control an actuator associated with the control.

According to an aspect of the present invention there is provided computer readable instructions which, when executed by a computer, are arranged to perform a method according to an aspect of the invention. The computer readable instructions may be stored on a computer readable medium. The computer readable instructions may be tangibly stored on the computer readable medium.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a vehicle according to an embodiment of the invention;

FIG. 2 shows a steering control of the vehicle;

FIG. 3 shows a steering system of the vehicle;

FIG. 4 shows a control system for a vehicle according to an embodiment of the invention;

FIG. 5 schematically illustrates a control system according to an embodiment of the invention;

FIG. 6 illustrates a method according to an embodiment of the invention;

FIG. 7 illustrates trajectories for the vehicle according to an embodiment of the invention;

FIG. 8 illustrates example force limits according to embodiments of the invention;

FIG. 9 illustrates an example force limit dependent on road position according to an embodiment of the invention;

FIG. 10 schematically illustrates a control system according to an embodiment of the invention;

FIG. 11 illustrates a method according to an embodiment of the invention;

FIG. 12 illustrates a trajectory offset according to an embodiment of the invention; and

FIG. 13 illustrates a further embodiment of the invention.

### DETAILED DESCRIPTION

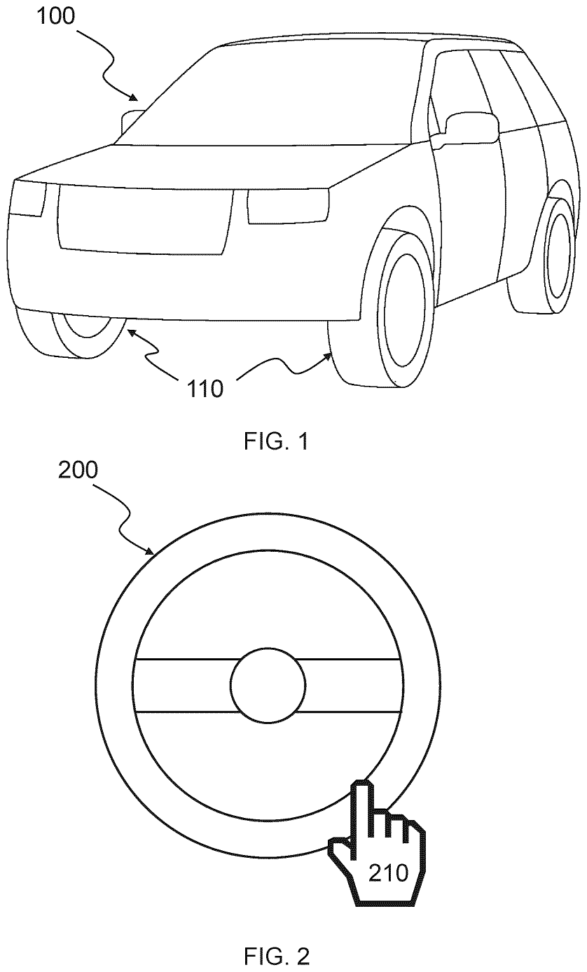

A vehicle 100 in accordance with an embodiment of the present invention is described herein with reference to the accompanying FIG. 1. As shown in FIG. 1, the vehicle 100 is a wheeled vehicle, such as an automobile, car, van etc., but it will be understood that embodiments of the present invention may be used in other types of vehicle having a steering control for controlling a direction of travel of the vehicle 100. The vehicle 100 comprises one or more steered wheels 110 i.e. wheels 110 used for steering the vehicle 100, which may be located generally at a front of the vehicle 100 (it will also be appreciated that wheels at the rear of the vehicle 100 may be used to steer the vehicle 100). The steered wheels 110 are controlled to determine a direction of travel of the vehicle 100, as will be appreciated. In other vehicles, the direction may be controlled by, for example, a rudder.

Within the vehicle 100, there is a steering control 200, as shown in FIG. 2, for receiving a driver steering input to control the steered wheels 110 of the vehicle 100. In the embodiment shown in FIG. 2 the steering control 200 is a steering wheel 200 which is rotated by the driver applying steering torque thereto, to provide the driver steering input indicative of a requested steering angle of the steered wheels 110. The driver steering input may have one or more of a direction, such as clockwise or counter-clockwise (which may be denoted by positive and negative values of input), a magnitude, such as a torque magnitude, and a speed i.e. a speed at which the steering wheel 200 is rotated by the driver. In other embodiments the steering control 200 may be, for example, a joystick which is moved or actuated in opposing directions to provide the driver steering input.

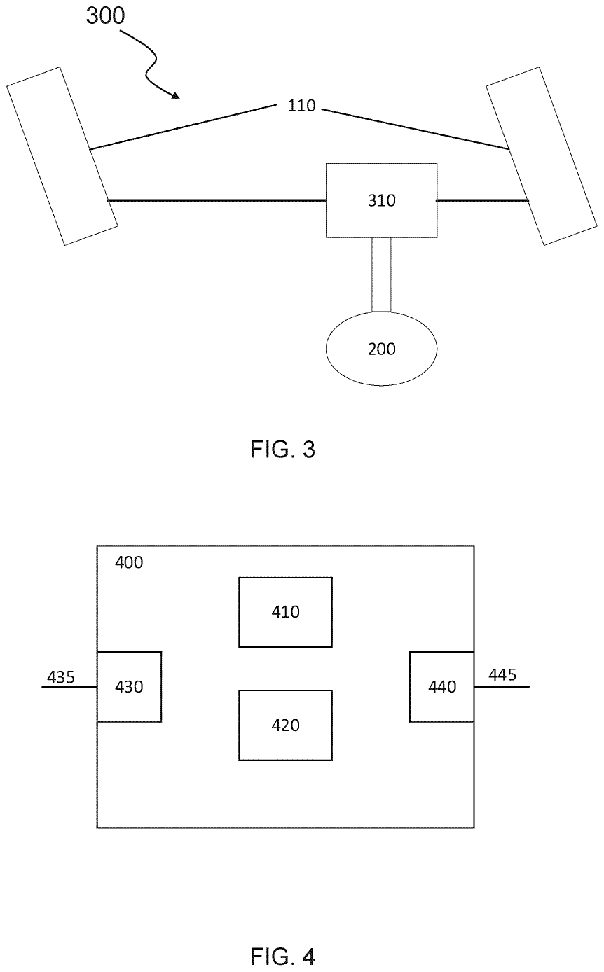

The driver steering input may be used to control a steering actuator 310, such as an electric motor, a linear actuator or one or more hydraulic rams, arranged to at least partially provide force to a steering system 300 of the vehicle 100, as shown in FIG. 3, to determine an angle of the steered wheels 110, which may be known as a road wheel angle (RWA). The steering actuator 310 may be used to assist the driver in controlling the angle of the steered wheels 110 in the form of a power assistance system (PAS). In some embodiments the PAS is electrically powered and may be known as an electrical power assistance system (EPAS) of the vehicle 100. One or more sensors may be arranged to measure rotation or a position of the steering wheel 200 to provide a signal which is used to control the steering actuator 310 such that force applied by the steering actuator 310 is in the same direction as that applied by the driver. In this way, the steering actuator 310 may assist the driver in setting and changing the angle of the steered wheels 110 of the vehicle 100.

The steering actuator 310 may also be controlled by an autonomous steering controller to provide at least partly autonomous driving of the vehicle 100 e.g. SAE level 3 or above. The autonomous steering controller is arranged to operably provide a control input to the steering actuator 310 which causes an application of force to the steering system 300 by the steering actuator 310. In order to provide feedback to the driver, the steering control 200 is arranged to reflect operation of the autonomous steering i.e. to be moved by the steering actuator 310 according to the autonomous steering input. For example, the steering wheel 200 may rotate according to the autonomous steering input. In this way, the driver is able to visually perceive an application of the autonomous steering input. Furthermore, when the driver is physically contacting the steering control 200, they are able to physically feel a force applied by the steering actuator 310 to the steering system 300 under control of the autonomous steering controller e.g. to feel rotation of the steering wheel 200.

A change in driving state may occur when transitioning between autonomous and driver control of the vehicle 100. For example, when the vehicle 100 is under autonomous steering control, the driver may contact the steering control 200 and begin to provide the driver steering input. That is, the driver may apply a steering input to the steering control 200 to at least begin to override the autonomous steering input to the steering system 300. At least initially, the driver is able to perceive the force applied to the steering system 300 by the steering actuator 310. It is therefore necessary to arbitrate between the driver steering input and the autonomous steering input. It is desired that a handover between the autonomous steering controller and the driver is smooth and comfortable to the driver. In particular, it is desirable that the driver does not feel that the autonomous steering controller is providing a steering input which acts significantly against the driver steering input. However, problems have been observed due to the steering actuator 310 being non-linear due to, for example, latency and temperature changes. Furthermore, problems may arise due to internal control and dynamics of steering column compliance and mechanical back lashes, non-linear chassis behaviour due to the suspension systems, and a non-linear driver performance. For these reasons, it is hard to develop deterministic control strategies that are able to provide a smooth transition between autonomous and driver in all scenarios or situations. Some current systems have logic which is arranged to activate based on a pre-defined torque threshold the driver applies at the steering control 200. These strategies then fade out or reduce over time the torque that the autonomous control strategy can apply. Such logic is static, hence they fail to provide a smooth transition all of the time.

FIG. 4 illustrates a control system 400 according to an embodiment of the invention. The control system 400 as illustrated in FIG. 4 comprises one controller 400, although it will be appreciated that this is merely illustrative. The controller 400 comprises processing means 410 and memory means 420. The processing means 410 may be one or more electronic processing device 410 or processor 410 which operably executes computer-readable instructions. The memory means 420 may be one or more memory device 420. The memory means 420 is electrically coupled to the processing means 420. The memory means 420 is configured to store the computer-readable instructions, and the processing means 410 is configured to access the memory means 420 and execute the instructions stored thereon.

The controller 400 comprises an input means 430 and an output means 440. The input means 430 may comprise one or more electrical inputs 430 of the controller 400 for receiving an electrical signal 435. The output means 440 may comprise one or more electrical outputs 440 of the controller 400 for outputting an electrical signal 445. In some embodiments the input 430 and output 440 of the controller 400 may be integrated into an I/O interface of the controller 400. The I/O interface may be a network interface for communicatively connecting the controller 400 to a communication network of the vehicle 100 such as a communication bus, as will be appreciated.

The controller 400 is arranged to receive a driver control signal 435 indicative of a driver input at the steering control 200, as discussed in more detail below. The controller 400 is arranged to control the steering actuator 310 of the vehicle 100. The controller 400 is arranged to output a steering actuator control signal 445 for controlling the steering actuator 310. The steering actuator control signal 445 may be indicative of a requested force output of the steering actuator 310 and a requested RWA of the steered wheels 110. Where the steering control 200 is rotary, i.e. a steering wheel 200, the steering actuator control signal 445 may be indicative of torque to be applied by the steering actuator 310.

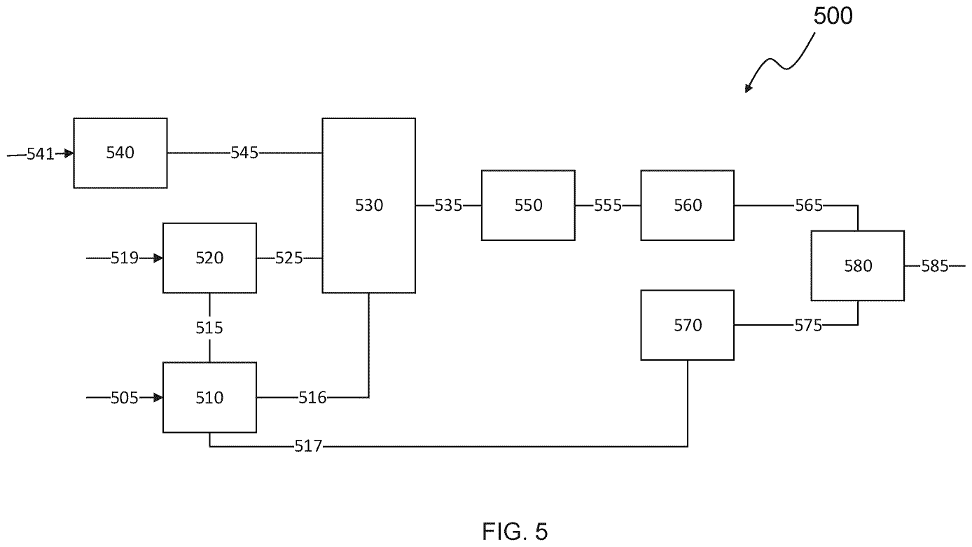

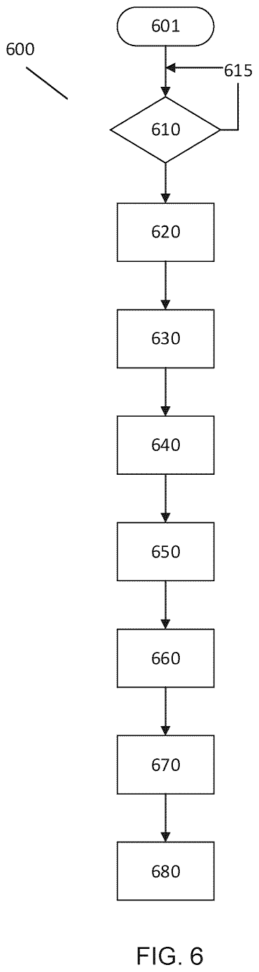

Referring to FIG. 5, there is schematically illustrated an architecture of control system 500 for controlling the steering actuator 310 of the vehicle 100 according to an embodiment of the present invention. The control system 500 may be implemented by the controller 400 illustrated in FIG. 4. The control system 500 is formed by a plurality of modules or units 510-590. The modules 510-590 may be implemented, in some embodiments, as software modules 510-590 executed by the processor 410 of the controller 400 illustrated in FIG. 4. It will be appreciated that in other embodiments the modules 510-590 may be implemented in hardware. A method 600 of controlling the steering actuator 310 of the vehicle 100 according to an embodiment is illustrated in FIG. 6 which is performed by the control system 500. For clarity, the steering control 200 will hereinafter be referred to as the steering wheel 200.

The control system 500 illustrated in FIG. 5 comprises a driver actuation manager 510, a driver trajectory estimator 520, a trajectory blending unit 530, a steering controller 550, a filter 560, a limit determiner 570 and an arbitrator 580. In some embodiments the control system 500 comprises a trajectory planning unit 540 as discussed below.

The method 600 begins in block 601. In block 610 the method 600 comprises determining a change in driving state of the vehicle. The change in driving state may be a request for handover of steering control of the vehicle 100.

The driver actuation manager 510 is arranged to determine, in block 610 of the method 600, the driving state of the vehicle 100. In particular, the driver actuation manager 510 is arranged to determine a requested handover or change in driving state between one of an least partly autonomous driving state and a driver-controlled driving state and the other, respective, state. The driver actuation manager 510 is arranged to determine a requested change from the autonomous driving state to the driver-controlled driving state and vice versa i.e. from the driver-controlled driving state to the autonomous driving state.

As shown in FIG. 5, the driver actuation manager 510 is arranged to receive one or more driver control signals 505 (hereinafter driver control signal 505) indicative of the driver steering input at the steering control 200 of the vehicle 100. The driver control signal 505 is indicative of a driving state requested by a person within the vehicle 100, typically a person seated in a seat of the vehicle 100 at which driving controls 200 of the vehicle 100 are located. Said seat is often referred to as the driver's seat of the vehicle 100, with it being appreciated that the person in said seat may not actually be driving the vehicle 100 when operative in the at least partly autonomous driving state.

The requested change in driving state is determined by the driver actuation manager 510 in dependence on the received driver control signal 505. Referring to FIG. 2, the driver control signal 505 may be indicative of physical contact of the driver 210 e.g. their hand 210 with the steering wheel 200 of the vehicle 100, such as the driver making physical contact with, i.e. touching the steering wheel 200. Physical contact may be detected by, for example, a conductive surface or portion of the steering control 200. It will also be appreciated that physical contact with the steering wheel 200 may be determined from image data from a camera within the vehicle, for example. In some embodiments, the requested change in driving state is determined by detecting or determining actuation of the steering wheel 200 by the driver. For example, by detecting that the driver is rotating, or has ceased to rotate, the steering wheel 200.

The driver control signal 505 may comprise a first part or contact signal indicative of the driver's physical contact with the steering wheel 200. The driver control signal 505 may in some embodiments comprise a second part or actuation signal indicative of actuation or movement of the steering wheel 200 by the driver. The requested change in driving state may be determined from the contact signal indicative of the driver contacting the steering wheel 200 and/or from the actuation signal indicative of movement of the steering wheel 200 by the driver.

When, or whilst, a requested change in driving state is not detected, the method 600 follows 615 and waits at block 610 until the requested change is detected.

In some embodiments, when the driver transitions from not being in contact with the steering wheel 200 to being in contact, as indicated by the driver control signal 505, the driver actuation manager 510 determines a requested change in driving state of the vehicle 100 from the autonomous driving state to the driver-controlled driving state. Similarly, when the driver control signal 505 indicates a transition from the driver being in contact with the steering wheel 200 to not being in contact, the driver actuation manager 510 determines a requested change from the driver-controlled driving state to the autonomous driving state. In both cases, the requested change corresponds to a handover request i.e. to handover between at least partly autonomous control and human (driver) control of the vehicle 100. Similarly, in other embodiments, the driver actuation manager 510 may determine when the driver actuates or moves the steering wheel 200 to determine the requested change in driving state of the vehicle 100 from the autonomous driving state to the driver-controlled driving state, or ceases to actuate or move the steering wheel 200 to determine the requested change from the driver-controlled driving state to the autonomous driving state. When the requested change in driving state or handover is detected by the driver actuation manager 510, the method 600 moves to block 620.

In response to the requested change in driving state, the driver actuation manager 510 is arranged to output a handover request signal 516 indicative of the requested change in driving state i.e. the handover request. The handover request signal 516 may indicate a direction of the handover request, which may be one of from at least partly autonomous control to driver control, or from driver control to at last partly autonomous control. The handover request signal 516 may, for example, be a first numeric value indicative of a requested handover from autonomous to human control and a second numeric value indicative of a requested handover from human to autonomous control, with it being appreciated that other signals may be envisaged. The handover request signal 516 may be received by the trajectory blending unit 530 as will be explained. In some embodiments the handover request signal 516 may also be provided to the arbitrator 580 indicative of a need to provide arbitration, as described below.

The driver actuation manager 510 is arranged to output one or more driver actuation signals 515 (hereinafter driver actuation signal 515) indicative of a driver steering input or actuation at the steering control 200 i.e. the steering wheel 200 in the described embodiment. The driver actuation signal 515 may be determined by the driver actuation manager 510 in dependence on the driver control signal 505. In some embodiments, the driver actuation signal 515 may correspond to the actuation signal part of the driver control signal 505, or be determined in dependence thereon.

The one or more actuation signals 515 may be indicative of one or more of a direction of the driver input i.e. left turn or anti-clockwise rotation of the steering wheel 200, right turn or clockwise rotation of the steering wheel, a torque (Tq) applied to the steering wheel 200 and a speed of rotation of the steering wheel 200 by the driver. It will be appreciated that other actuation signals may be envisaged. The one or more actuation signals 515 are provided to the driver trajectory estimator 520. The driver actuation manager 510 may, in some embodiments, output a driver torque signal 517 indicative of the rotational torque (Tq) applied to the steering wheel 200 by the driver, as will be explained.

The driver trajectory estimator 520 is arranged to receive the one or more actuation signals 515 (hereinafter actuation signal 515) indicative of the driver's actuation of the steering wheel 200 in the described embodiment. In block 620 of the method 600, in dependence on the actuation signal 515, the driver trajectory estimator 520 is arranged to determine a driver trajectory for the vehicle 100. The driver trajectory is a prediction or estimation of where the driver wishes the vehicle 100 to travel i.e. an estimation of the vehicle trajectory controlled by the driver. In other words, the driver trajectory is a prediction or estimation of the driver's intended trajectory for the vehicle 100. The driver trajectory may be determined between a current point in time and a time horizon. The time horizon may be a predetermined time in the future, such as 100 ms, 200 ms, 500 ms etc. The time horizon may be equal to a time horizon for which an autonomous trajectory is determined, as explained below. The driver trajectory estimator 520 determines the driver trajectory in dependence on the actuation signal 515 which provides an indication of the driver's steering input at the steering wheel 200. In some embodiments, the driver trajectory may be determined in dependence on data 519 indicative of the environment of the vehicle which may improve the prediction of the driver trajectory.

The driver trajectory estimator 520 may receive environment data 519 relating to one or both of an environment proximal to the vehicle 100 and the vehicle's relationship to the environment, such as the vehicle's heading e.g. compass direction or geographic position. The environment data 519 may be used in determining the driver trajectory in block 620. However, as will be explained below, in other embodiments the driver trajectory may be determined without use of the environment data 519. In the embodiment illustrated in FIG. 5 the environment data 519 provided to the driver trajectory estimator 520 may comprise one or more of heading data indicative of a current heading of the vehicle 100, position data indicative of a current position of the vehicle 100, such as longitude and latitude for example, or a position with respect to a road, map data indicative of a layout of a road network proximal to the vehicle 100, and image data from one or more cameras associated with the vehicle 100 relating to the environment. The heading data may be indicative of a geographic or compass heading of the vehicle 100, such as may be determined by a magnetometer associated with the vehicle 100. The position data may be indicative of a position of the vehicle with respect to a road or other navigable path on which the vehicle 100 is located. The position data may be determined in dependence on data from one or more sensors such as cameras or a LiDAR scanner, for example. The map data may be obtained from a map data server or other data store accessible to the system 500. The map data may provide the driver trajectory estimator 520 with data indicative of the road or path on which the vehicle is located, such as indicative of a layout, width, number of lanes etc. of the road as will be appreciated. The image data may relate to the environment of the vehicle 100, such as capturing at least a portion of the road around the vehicle, particularly ahead of the vehicle 100. In such case the image data may provide an indication of any obstacles or obstructions proximal to the vehicle 100, such as within the road or lane of the vehicle 100, or an indication of a layout of the road on which the vehicle 100 is located. The image data may alternatively or additionally relate to an interior of the vehicle 100, particularly including an image of the driver of the vehicle 100 to provide an indication of the driver's intent for the vehicle 100, such as an indication of a position of the driver's hand(s) 210, or a gaze direction of the driver.

The driver trajectory estimator 520 may comprise a trained driver trajectory model. The driver trajectory model is for predicting the driver trajectory. The driver trajectory model may comprise an artificial intelligence (AI) or machine learning (ML) function for determining the driver trajectory. The driver trajectory model is trained to estimate the driver trajectory based on one or more inputs 515, 519. The driver trajectory model may comprise a network, such as a neural network or artificial neural network (ANN), which is trained to estimate the driver trajectory based on one or more inputs 515, 519. In the illustrated embodiment, the inputs 515, 519 used by the driver trajectory model comprise the actuation signal 515 described above, such as indicative of the direction, torque and/or speed of the driver's input to the steering wheel 200. The driver trajectory model is pre-trained, i.e. prior to first utilisation of the system 500, to determine the driver trajectory based on training data corresponding to the actuation signal 515 and/or the environment data 519. In this way, when first used based upon ‘real’ input data, the driver trajectory model is able to predict the driver trajectory more accurately. In use, the driver trajectory model is updated based on actual driver trajectory data i.e. data relating to historic or experienced driver trajectories. The actual driver trajectory data is indicative of an actual trajectory followed by the vehicle 100, such that the driver trajectory model accuracy may improve. In some embodiments, each time a handover occurs, a new set of driver trajectory data is obtained upon which the driver trajectory model may be updated or trained, such as in a supervised learning process. In this way, over time, the driver trajectory model of the driver trajectory estimator 520 becomes more representative of the actual driver's trajectories. Furthermore, in some embodiments, using driver identification the driver trajectory model may be personalised to a particular driver, or each of a plurality of drivers, to better represent each driver's trajectories. The driver identification may be achieved through recognition of an electronic device associated with the driver, such as a key fob or mobile telephone for example, or via recognition of one or more biometric attributes such as fingerprint, DNA, or facial features of the driver. Thus, in some embodiments, an attribute of the input data 515 may identify the driver.

The determination of the driver trajectory by the driver trajectory estimator 520 may be based on the environment data 519 as described above. For example, using object recognition performed upon the image data capturing the exterior of the vehicle 100, a moving object such as another vehicle, a person, a static object such as a traffic cone, rock, etc, may be identified. Identification of the object and providing an indication of the object to the driver trajectory model provides additional data on which the estimate of the driver trajectory may be based. For example, when an object lying in a lane of the road is identified within the image data and the driver's steering input corresponds to a turn of the vehicle 100, the driver trajectory model may infer the driver trajectory is to avoid the object.

In some embodiments, the driver trajectory determined by the driver trajectory estimator 520 is subject to one or more constraints or checks to ensure that it is suitable for use i.e. is valid. In some embodiments, only if the determined driver trajectory passes the one or more checks is the trajectory used further. The one or more checks may comprise one or more of the driver trajectory being collision free i.e. not colliding with a detected object in the environment of the vehicle 100, that the driver trajectory lies within boundaries of a navigable area such as the road, which may be determined with respect to the map data and/or image data relating to the road, and that the driver trajectory is feasible for the vehicle 100 i.e. that it can be physically achieved by the vehicle 100. That the trajectory can be achieved by the vehicle 100 may be determined with respect to a model, e.g. kinematic model, of the vehicle 100. The model of the vehicle 100 may assume that the vehicle 100 steers with a pure-kinematic movement and/or natural steering behaviour. Advantageously checking the determined driver trajectory in this way helps to reduce erroneously determined driver trajectories.

In some embodiments, the driver trajectory estimator 520 may comprise a driver trajectory filter for filtering the determined driver trajectory 525. Filtering the estimated driver trajectory may assist in smoothing the trajectory, which may be useful where the estimated driver trajectory is over-fitted. In some embodiments the driver trajectory filter may be a zero-phase filter.

An output of the driver trajectory estimator 520 is driver trajectory data 525 indicative of the determined driver trajectory. The driver trajectory data 525 is provided to the trajectory blending unit 530 as shown in FIG. 5.

The trajectory blending unit 530 is arranged to receive the driver trajectory data 525 and autonomous trajectory data 545. The autonomous trajectory data 545 is indicative of an autonomous trajectory, i.e. an autonomously determined trajectory, for the vehicle 100. The autonomous trajectory data 545 may be provided from a source outside of the system 500, such as an external control system or trajectory planner responsible for determining the autonomous trajectory for the vehicle 100. In the example embodiment shown in FIG. 5, the autonomous trajectory data 545 is provided from a trajectory planning unit 540 with it being appreciated that the trajectory planning unit 540 may not form part of the present system 500 i.e. may be an external or separate unit.

The autonomous trajectory for the vehicle 100 may be determined in dependence on environment data 541 relating to an environment of the vehicle 100 e.g. map data etc., as will be appreciated by the skilled person. The environment data 541 used by the trajectory planning unit 540 may comprise at least some of the environment data 519 used by the driver trajectory estimator 520. The autonomous trajectory data 545 received by the trajectory blending unit 530 is indicative of an autonomously determined intended path of the vehicle 100. The autonomous trajectory data 545 may define the desired path of the vehicle 100 between the current point in time and the time horizon a predetermined time in the future, such as 100 ms, 200 ms, 500 ms etc.

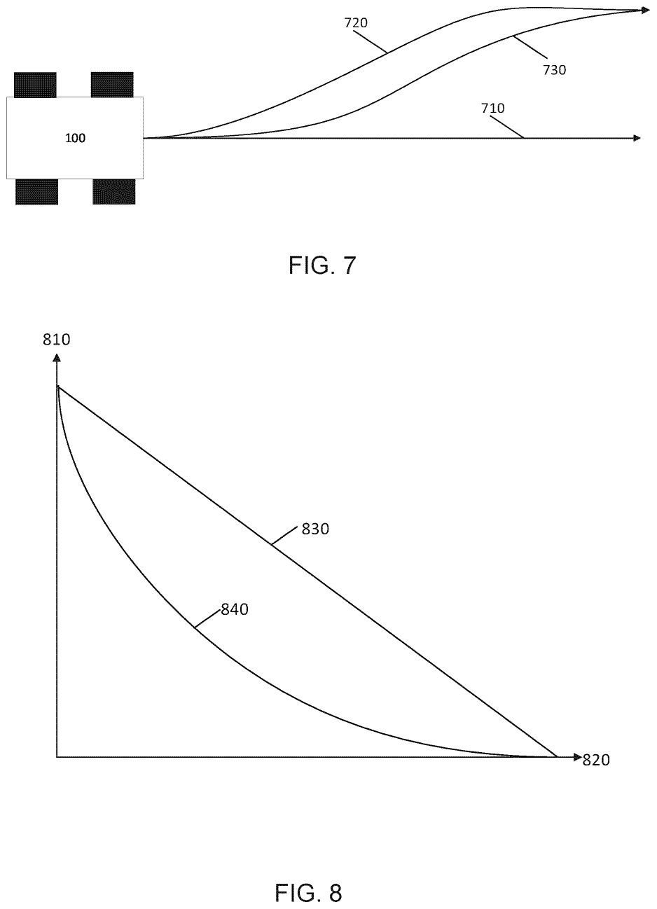

Block 630 of the method 600 comprises determining a combined or blended trajectory for the vehicle 100. The combined trajectory may be determined in dependence on the autonomous trajectory and the driver trajectory. Block 630 will be explained with reference to FIG. 7 which illustrates a current location of the vehicle 100 in relation to an example autonomous trajectory 710 and an example driver trajectory 720. In the example shown in FIG. 7 the autonomous trajectory 710 lies directly ahead of the vehicle 100 i.e. is generally a straight ahead path which may follow a generally straight road or lane of a road. However, as can be appreciated, the driver trajectory 720 deviates from the autonomous trajectory 710. In the example, the driver trajectory 720 follows a path curving away from the path of the autonomous trajectory 710, before assuming a generally straight path. The driver trajectory may thus be an example of a lane change manoeuvre to a lane adjacent a current lane of the vehicle 100. The driver 100 may have perceived a need for the vehicle 100 to change lanes and provided corresponding steering input to the steering wheel 200.

In block 630 the trajectory blending unit 530 is arranged to determine a combined trajectory 730, as illustrated in FIG. 7, in dependence on the autonomous trajectory 710 and the driver trajectory 720. The combined trajectory 730 is a blended or weighted combination of the autonomous trajectory 710 and the driver trajectory 720. In some embodiments the blend or weighting of the two trajectories 710, 720 gradually changes to smoothly combine the two different trajectories 710, 720. Trajectory blending strategies for combining two input trajectories are known in the art, such as in EP2143611 which is herein incorporated by reference. Furthermore, the combined trajectory 730 may be smoothed by the trajectory blending unit 530, such as by using a filter e.g. a zero-phase filter, although it will be appreciated that other filters may be used.

As shown in FIG. 5, the trajectory blending unit 530 is arranged to receive the handover request signal 516 indicative of the requested change in driving state. The trajectory blending unit 530 may determine the combined trajectory 730 in dependence on receipt of the handover request signal 516. That is, the combined trajectory 730 may be determined by the trajectory blending unit 530 in dependence on the change of driving state of the vehicle 100 being determined as in block 610.

The trajectory blending unit 530 may combine the autonomous trajectory 710 and the driver trajectory 720 in order to gradually transition from one trajectory to the other, dependent on a direction of handover. For example, when the handover is from autonomous control to driver control, the trajectory blending unit 530 is arranged to gradually reduce a proportion or influence of the autonomous trajectory 710 on the combined trajectory 730, whilst increasing a proportion or influence of the driver trajectory 720. The trajectory blending unit 530 may be arranged to transition from the combined trajectory 730 corresponding substantially to one of the input trajectories, such as the autonomous trajectory 710, to the other trajectory, such as the driver trajectory, as quickly as possible or within a transition time period. When attempting to transition as quickly as possible one or more constraints may be applied to the transition to limit a rate at which the transition occurs. For example, the trajectory blending unit 530 may limit the transition to a maximum lateral acceleration of the vehicle 100 e.g. to maintain comfort within the vehicle 100. Other constraints may be envisaged. For example, the constraints may include one or more of lateral jerk of the vehicle 100, lateral displacement of the vehicle 100 due to the trajectory being outside of a boundary, and lateral speed of the vehicle 100. The boundary is associated with the trajectory and defines a driveable area i.e. in which the vehicle 100 may move. Thus the boundary defines a tolerance on one or both sides of the trajectory. Data defining the boundary may be provided by the trajectory planning unit 540. Furthermore, in some embodiments, the constraints may include a selection of a driving mode of the vehicle, such as economy, comfort, dynamic, sport, off-road as examples.

The steering controller 550 is arranged to control the steering wheels 110 of the vehicle 100 in dependence on the trajectory to be followed by the vehicle 100. In particular, the steering controller 550 is arranged to control the steering system 300 to achieve, as closely as possible, the trajectory. As will be appreciated, the steering controller 550 may use a model predictive control (MPC) scheme to achieve the control of the steering wheels 110 for the vehicle 100 to follow a desired trajectory. MPC uses one or more models of the vehicle 100 e.g. to model steering of the vehicle 100 to determine a steering input for the vehicle 100 which aims to achieve the desired trajectory, such as the combined trajectory 730. The steering controller 550 is arranged to determine a control input 555 for the steering actuator 310 of the vehicle 100 for the vehicle 100 to follow the combined trajectory 730. The control input 555 for the steering actuator 310 may be indicative of a requested angle of the steering wheels 110 i.e. a requested RWA. Thus the steering controller 550 may be arranged to determine the control input 555 indicative of the requested RWA. In some embodiments, the control input 555 may be indicative of a torque (Tq) to be applied by the steering actuator 310 to the steering system 300 of the vehicle 100. However, in embodiments where the control input is indicative of the requested RWA, the steering actuator 310 is arranged to determine, using an associated controller, a torque request e.g. to be applied by an electric motor of the steering actuator. Where the control signal 555 is indicative of the RWA and the steering actuator 310 determines the applied torque better angle control of the steering wheels 110 may be achieved.

An input 535 to the steering controller 550 is indicative of an error between the desired trajectory and an actual or current trajectory of the vehicle 100. The steering controller 550 is arranged to determine the control input 555 for the steering actuator 310 which minimises the error, as will be appreciated. In block 640 of the method, the trajectory blending unit 530 may determine an error input 535 for the steering controller 530. The error input 535 for the steering controller 310 is determined in dependence on the autonomous trajectory 710 and the driver trajectory 720. In the illustrated embodiment the error input 535 is determined in dependence on the combined trajectory 730. The error input 535 is determined by the trajectory blending unit 530 between an actual or current trajectory of the vehicle 100 and the combined trajectory 730. An output of the trajectory blending unit 530 may be error data 535 indicative of the error between the current trajectory and the combined trajectory 730. For example, the error data 535 may indicate an error in a lateral position and heading of the vehicle 100.

In block 650 of the method 600, the steering controller 550 is arranged to determine the control input 555 for the steering actuator 310 in dependence on the received error input 535. The steering controller 550 may determine the control input 555 comprising the requested angle of the steering wheels 110 of the vehicle 100 as discussed above i.e. the RWA. The control input 555 may comprise an indication of the torque to be applied by the steering actuator 310 to the steering system 300 to achieve the requested angle of the steering wheels 110. Data indicative of the control input 555 for the steering actuator 310 is output from the steering controller 550 in block 650 of the method 600.

In some embodiments, the control system 500 comprises a filter or rate limiter 560. The filter 560 is for applying filtering to, or limiting a rate of change of, the control input 555. In particular, the filter 560 may be arranged to filter or limit the rate of change of one or both of the requested angle of the steering wheels 110 and the applied torque value. In this way, abrupt changes in the steering angle and/or applied torque may be reduced or avoided. The filter 560 is arranged to receive the control data 555 from the steering controller 550 and to output filtered control data 565 to the arbitrator 580.

In block 660 of the method 600, the limit determiner 570 is arranged to determine one or more limits for a magnitude of the control input to the steering actuator 310. In particular, the one or more limits may comprise at least one limit of a magnitude of the force applied by the steering actuator 310. In some embodiments, the one or more limits comprise one or more torque magnitude limits for the steering actuator 310. The one or more limits may comprise a maximum and a minimum torque limit in some embodiments. For example, the positive and negative torque limits may relate to opposing directions of movement of the steering control 200, such as anti-clockwise and clockwise rotation of the steering control 200 where the negative torque limit relates to a first direction of movement and the positive torque limit relates to a second direction of movement. In some embodiments the positive and negative torque limits have equal magnitude, whilst in other embodiments they may differ in magnitude. That is, the positive and negative limits may be symmetric (same absolute value but opposite in sign), but it is not necessary always the case, other situations may set one of the limits to be zero (no limitation on the selected direction) and the other value to be non-zero wherein the limitation is only applied in one direction.

As discussed above, when the steering actuator 310 provides a physical input to the steering system 300 of the vehicle 100, the steering wheel 200 is arranged to correspondingly rotate. Initially, the steering actuator 310 is controlled so that the vehicle 100 follows the autonomous trajectory with the steering wheel 200 rotating according to the steering actuator input. As the driver contacts the steering wheel 200 to provide the driver steering input to follow the driver trajectory 720, the driver is able to feel the steering wheel 200 being moved by the steering actuator 310. Furthermore, as the driver steering input causes the vehicle 100 to deviate from the autonomous trajectory 710, the driver may perceive the force input from the steering actuator 310 to act against their inputs to the steering wheel 200, which may be disconcerting for the driver. Therefore, the limit determiner 570 is arranged to dynamically limit the force or torque applied by the steering actuator 310 to the steering wheel 200, thereby improving the driver's experience.

The limit determiner 570 is arranged to determine the one or more limits in dependence on one or more parameters 517 associated with the vehicle 100. The one or more limits act to limit a force to be applied by the steering actuator 310 to the steering system 300 of the vehicle 100. In particular, the one or more limits may limit the force to be applied by the steering actuator 310 which is perceived by the driver at the steering wheel 200 of the vehicle 100. In this way, a perception by the driver of steering force from the autonomous control of the vehicle 100 is controlled.

The limit determiner 570 is arranged to receive vehicle data 517 indicative of the one or more parameters 517 associated with the vehicle 100. The one or more parameters associated with the vehicle 100 may comprise one or more of a speed, a yaw rate, a lateral acceleration, and jerk of the vehicle 100. The vehicle data 517 may be obtained from a communication bus of the vehicle 100 as will be appreciated. In the illustrated embodiment, the one or more parameters are obtained from the driver actuation manager 510. In some embodiments, the one or more parameters comprise a time horizon for determining the control input for the vehicle 100.

The one or more limits determined in block 660 by the limit determiner 570 may comprise one or both of a maximum torque limit and a minimum torque limit. The maximum torque limit may be a maximum torque magnitude applied by the steering actuator 310. The minimum torque limit may be a minimum torque magnitude applied by the steering actuator 310. The one or more limits are dynamic in that they may vary over time. In particular, when the handover is autonomous to driver control the one or more limits may decrease in magnitude over time, whereas when the handover is driver to autonomous control the one or more limits may increase in magnitude over time.

FIG. 8 illustrates an example maximum torque limit 810 against time 820. FIG. 8 illustrates an example first torque limit 830 and an example second torque limit 840 which are dynamic i.e. vary over time. In particular, it can be appreciated that both the first torque limit 830 and the second torque limit 840 decrease over time. Thus the first and second torque limits 830, 840 may be torque limits used during a handover from autonomous control to driver control of the vehicle 100. Furthermore, as can be appreciated from FIG. 8, the first torque limit 830 is linear in nature i.e. with a constant rate of decrease from a maximum magnitude to a minimum magnitude, which is zero in the example. The second torque limit 840 is non-linear. The second torque limit 840 varies according to a predetermined function over time. In this way, various strategies can be envisaged for dynamically controlling or setting the one or more limits. During a handover from autonomous control to driver control of the vehicle 100 torque applied by the steering actuator 310 under autonomous control may be ramped down, or faded out, over time. In this way, the driver is able to gradually assume control of the vehicle 100.

As noted above, the limit determiner 570 is arranged to receive vehicle data 517 indicative of the one or more parameters 517 associated with the vehicle 100 and to determine the one or more torque limits 830, 840 in dependence thereon. For example, at least one of the torque limits 830, 840 may be determined in dependence on a speed of the vehicle 100. In one embodiment, a handover time t over which the one or more limits 830, 840 are varied, such as reduced, may be determined in dependence on the speed of the vehicle 100 such that at greater speeds t is lower. In this way when travelling at higher speed the handover between autonomous and driver control is performed more quickly i.e. in reduced time, whereas at slower speeds it is performed more slowly i.e. with increased t.

The one or more one or more limits determined in block 660 by the limit determiner 570 may be determined in dependence on one or more driver preferences. For example, a driver is able to provide an indication as to whether a greater handover time t is preferred or a shorter handover time. In some embodiments, the handover time t may be set according to the driver's steering input. In one embodiment, a greater magnitude or speed of driver steering input causes a reduction in the handover time t, such that the handover speed from autonomous to driver control is reduced. Correspondingly, a lower magnitude or speed of driver steering input causes an increase in the handover time t.

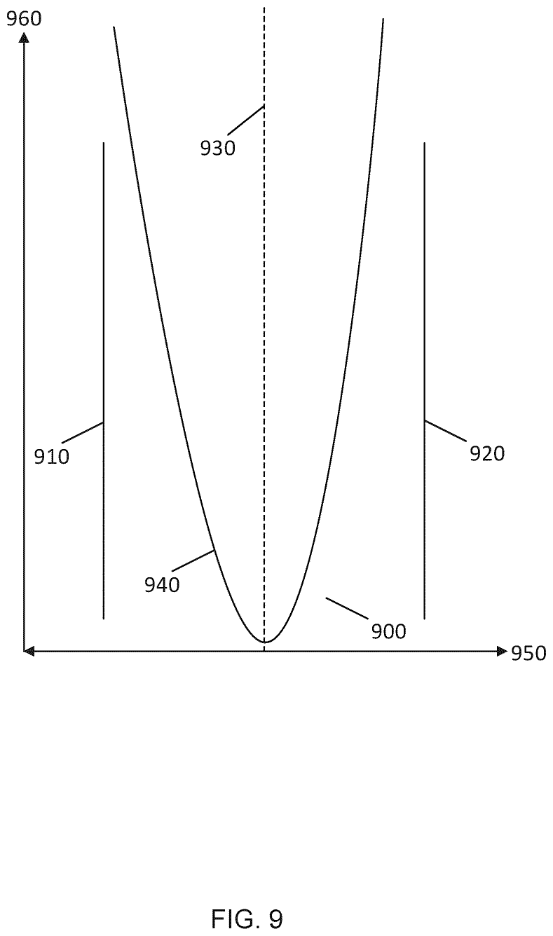

FIG. 9 illustrates a lane of a roadway generally denoted as 900 within which the vehicle 100 is travelling. The lane 900 is bounded by first and second lateral sides denoted as 910, 920 respectively. A centreline of the roadway is illustrated as 930. FIG. 9 also illustrates a maximum torque limit 940, a magnitude of the torque 960 varying in dependence on lane position 950. When the vehicle 100 is positioned at a centre of the lane 900 on the centreline 930, the maximum torque magnitude is relatively low, as can be appreciated, whereas when the vehicle is positioned closer to either the first or second sides 910, 920 the maximum torque magnitude is increased. The position of the vehicle 100 within the lane 900 may be determined with a forward-facing camera, for example with data indicative of the position provided to the limit determiner 570, in some embodiments.

Limit data 575 indicative of the one or more limits, such as one or both of the minimum and maximum torque limits, is provided to the arbitrator 580. The arbitrator 580 is arranged to receive the control data 555 indicative of the control input 565 output from the steering controller 550 (which may be via the filter 560 in some embodiments) and the limit data 575 from the limit determiner 570. As discussed above, the control input 555 is indicative of one or both the requested angle of the steering wheels 110 of the vehicle 100 i.e. the RWA and an indication of the torque to be applied by the steering actuator 310 to the steering system 300.

In block 670 of the method 600, the arbitrator 580 is arranged to arbitrate the control data 555, 565 in dependence upon the limit data 575. That is, the arbitrator 580 performs arbitration of the control input 565 for the steering actuator 310 in dependence on the one or more limits determined by the limit determiner 570. The control input 565 may be controlled according to the one or more limits, such as the maximum and minimum torque limits. For example, torque value to be output by the steering actuator 310, as indicated in the control input 565, may be controlled by the arbitrator 580 to be less than or equal to the maximum torque limit and/or above the minimum torque limit. The indicated torque value may be capped at the maximum torque value and above the minimum torque value. As discussed above, when, for example, the maximum torque value decreases over time during a handover from autonomous to driver control, the torque applied to the steering wheel 200 which is perceived by the driver in contact with the steering wheel 200 reduces accordingly thereby giving the driver an experience of a comfortable transition whilst taking control of the vehicle 100. Similarly, during a transition from driver to autonomous control the torque gradually increases which gives the driver a reassuring experience of the autonomous control taking over.

In block 680 of the method 600 the arbitrator 580 is arranged to output a signal 585 indicative of the control input 585 for the steering actuator 310 of the vehicle 100. The signal comprises arbitrated control data 585 which may be indicative of the force to be applied by the steering actuator 310, such as the torque value to be applied to the steering system 300 and steering wheel 200 of the vehicle 100.

It will be appreciated that blending or combining the driver trajectory and the autonomous trajectory whilst controlling a force applied to the steering system 300 by the steering actuator 310 provides an improved driver experience whilst addressing issues with autonomous control of the steering system, such as non-linearity of the steering actuator 310. In more detail, the trajectory determined provides a path for the vehicle 100 whilst limiting torque provides both a limit in a rate of change of applied torque which is experienced by the driver via the steering control 200, and a limit on force by the steering system when the driver is attempting to take full or partial control of the steering system 300. Trajectory blending allows the autonomous system to control the vehicle 100 to drive where the driver wishes to go. However, if there is only the trajectory blending, the overall driver feeling at the steering control 200 will be deteriorated due to latencies in the blending logic that estimates the driver's intention. Whilst the driver is taking control of the vehicle 100, if the driver applies relatively small steering corrections, these might not be predicted quickly by the trajectory blending and the driver may feel the steering control opposing these minor corrections. By providing torque blending embodiments of the invention allow the driver to perform such small corrections while ensuring the controller is still steering the car in the direction the driver wishes to take.

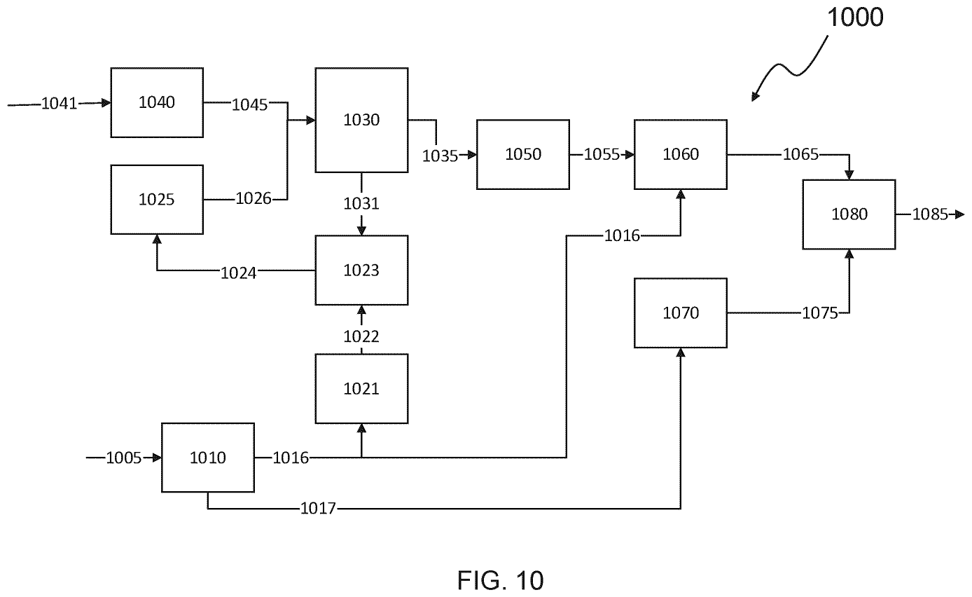

FIG. 10 illustrates an architecture of control system 1000 for controlling the steering actuator 310 of the vehicle 100 according to another embodiment of the present invention. The control system 1000 may be implemented by the controller 400 illustrated in FIG. 4. The control system 100 is formed by a plurality of modules or units 1010-1090. The modules 1010-1090 may be implemented, in some embodiments, as software modules 1010-1090 executed by the processor 410 of the controller 400 illustrated in FIG. 4. It will be appreciated that in other embodiments the modules 1010-1080 may be implemented in hardware.

The control system 1000 has some common modules to the control system 500 illustrated in FIG. 5. Modules in the system 1000 having consistent least two significant digits as in the system 500 of FIG. 5 have equivalent function, unless otherwise described and the reader is referred to the description above.

The control system 1000 comprises, inter-alia, a driver actuation manager 1010, a driver trajectory determiner 1021, a trajectory offset determiner 1023, a learned trajectory unit 1025 and a trajectory blending unit 1030.

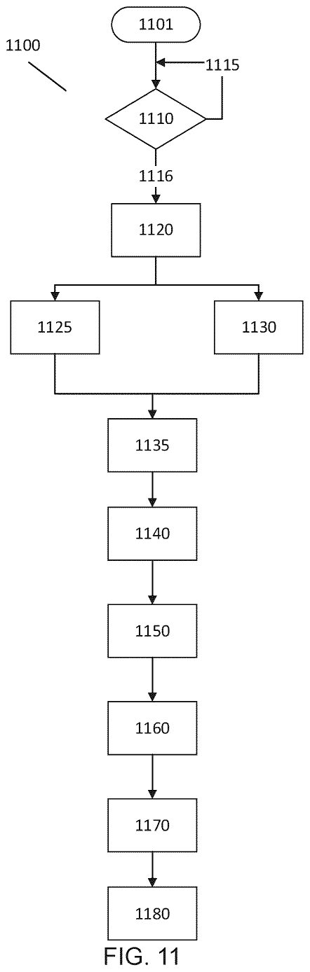

A method 1100 of controlling the steering actuator 310 of the vehicle 100 according to a further embodiment of the invention is illustrated in FIG. 11. The method 1100 may be performed by the control system 1000 of FIG. 10.

The method 1100 begins in block 1101. In block 1110 the method 1100 comprises determining a driving state of the vehicle 100. The driver actuation manager 1010 is arranged to determine, in block 1110 of the method 1100, the driving state of the vehicle 100. In particular, the driver actuation manager 1110 is arranged to determine when the vehicle 100 is in a driver-controlled driving state. The driver actuation manager 1100 is arranged to receive one or more driver control signals 1005 (hereinafter driver control signal 1005) indicative of the driver steering input at the steering control 200 of the vehicle 100. The determination of the driver-controlled driving state may be performed as described above with reference to FIGS. 5 and 6. The driver actuation manager 1010 is arranged to output a driver-in-control signal 1016 indicative of the driver-controlled driving state of the vehicle 100 i.e. when the driver is controlling the vehicle 100, particularly the vehicle's steering. In some embodiments, the driver-in-control signal 1016 may also be provided to filter 1060, as discussed below. The driver may be in control of the vehicle after having achieved a handover from the autonomous steering controller. The driver-in-control signal 1016 is received by the driver trajectory determiner 1021. If the vehicle 100 is not being driver controlled, the method 1100 returns i.e. waits at block 1110 by following path 1115. However, if the vehicle 100 is driver controlled the method 1100 follows path 1116 to block 1120

In some embodiments, the driver-in-control signal 1016 is indicative of the driver's steering input or actuation at the steering wheel 200. That is, the driver-in-control signal 1016 may comprise an actuation signal. The driver-in-control signal 1016 may be determined by the driver actuation manager 1010 in dependence on the received driver control signal 1005 as described above.

The driver-in-control signal 1016 may be indicative of one or more a direction of the driver input i.e. left turn or anti-clockwise rotation of the steering wheel 200, right turn or clockwise rotation of the steering wheel, a torque (Tq) applied to the steering wheel 200 and a speed of rotation of the steering wheel 200 by the driver. It will be appreciated that other actuation signals may be envisaged. The driver actuation manager 1010 may be arranged to output a driver torque signal 1017 indicative of the rotational torque (Tq) applied to the steering wheel 200 by the driver, as previously explained. The driver torque signal 1017 is received by a limit determiner 1070 as in the embodiment described above.

The driver trajectory determiner 1021 is arranged to receive the driver-in-control signal 1016 indicative of the driver's steering input or actuation at the steering wheel 200. In block 1120 of the method 1100, in dependence on the driver-in-control signal 1016, the driver trajectory determiner 1021 is arranged to determine an actual driver trajectory for the vehicle 100. The actual driver trajectory is a current trajectory of the vehicle as controlled by the driver i.e. when the driver is in control of the vehicle 100. The actual driver trajectory is the current trajectory of the vehicle 100 based on the driver's inputs to the steering control 200. Thus, the actual driver trajectory of the vehicle 100 determined in block 1120 is that which is currently being followed by the vehicle 100 under the driver's control, rather than a predicted driver trajectory as in the embodiment of FIG. 5.

An output 1022 of the driver trajectory determiner 1021 is vehicle trajectory data 1022 indicative of the actual trajectory of the vehicle 100 as determined in block 1120. The vehicle trajectory data 1022 is provided to the trajectory offset determiner 1023 as shown in FIG. 10.

The trajectory offset determiner 1023 is arranged to determine a trajectory offset in dependence on the actual driver trajectory and, at least in part, on an autonomous trajectory. The autonomous trajectory is, as discussed above, an autonomously determined trajectory, for the vehicle 100. The autonomous trajectory is indicated by autonomous trajectory data 1045 output by a trajectory planning unit 1040. The autonomous trajectory data 1045 may be provided from a source outside of the system 1000, such as an external control system or trajectory planner responsible for determining the autonomous trajectory for the vehicle 100. In the example embodiment shown in FIG. 10, the autonomous trajectory data 1045 is provided from the trajectory planning unit 1040 with it being appreciated that the trajectory planning unit 1040 may not form part of the present system 1000 i.e. the trajectory planning unit 1040 may be an external or separate unit, such as a cloud computer.

As discussed above, the autonomous trajectory for the vehicle 100 may be determined in dependence on environment data 1041 relating to an environment of the vehicle 100 e.g. map data, sensor data etc., as will be appreciated by the skilled person. The autonomous trajectory data 1045 received by the trajectory blending unit 1030 is indicative of an autonomously determined intended path of the vehicle 100. The autonomous trajectory data 1045 may define the desired path of the vehicle 100 between the current point in time and the time horizon which is a predetermined time in the future, such as 100 ms, 200 ms, 500 ms etc.

Block 1125 of the method 1100 comprises determining the trajectory offset which is performed by the trajectory offset determiner 1023. Block 1130 of the method 1100 comprises determining a combined trajectory for the vehicle 100 which is performed by the trajectory blending unit 1030. Block 1125 may be performed at least partly in parallel, i.e. at least partly at the same time, with block 1130 of the method 1100 as illustrated in FIG. 11.

The trajectory offset determiner 1023 is arranged to receive the vehicle trajectory data 1022 and an output 1031 of the trajectory blending unit 1030. The output 1031 of the trajectory blending unit 1030 is indicative of a blended or combined trajectory in the form of combined trajectory data 1031. The trajectory offset determiner 1023 is arranged to determine an offset between the combined trajectory from the trajectory blending unit 1030 and the actual driver trajectory, as will be explained.

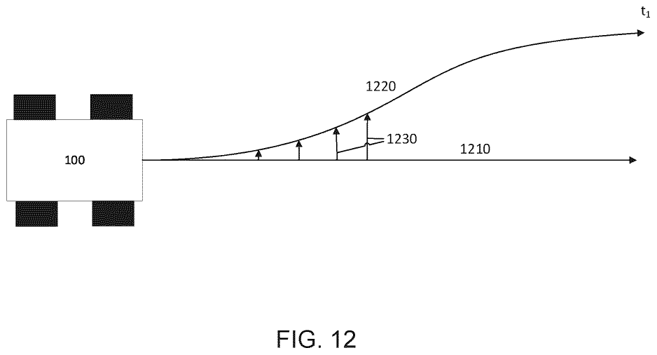

FIG. 12 illustrates the vehicle 100 in relation to a combined trajectory 1210 for the vehicle 100 and the actual driver trajectory 1220 of the vehicle 100 over a period of time. As can be appreciated, the actual driver trajectory 1220 of the vehicle 100 deviates increasingly from the combined trajectory 1210. For example, the driver may express a preference for a different path or position of the vehicle 100 and control the vehicle 100 accordingly using the steering control 200, such as to steer the vehicle 100 away from the determined combined trajectory 1210. At each of a plurality of points in time, a trajectory offset 1230 is determined by the trajectory offset determiner 1023 between the combined trajectory 1210 and the actual driver trajectory 1220. An indication of the trajectory offset 1230 is output by the trajectory offset determiner 1023 in the form of trajectory offset data 1024. The trajectory offset data 1024 is received by the learned trajectory unit 1025. Trajectory offset data 1024 at each interval or period of time may be output by the trajectory offset determiner 1023.

The trajectory offset 1230 determined by the trajectory offset determiner 1023 may comprise one or more of a position of the vehicle 100 in a road or lane i.e. lateral displacement, reference speed, reference curvature and reference yaw angle. In this context, the term reference may be understood to mean set points such as speed, curvature etc defining the trajectory path to be followed, which may be defined by the trajectory planning unit 1040.

In block 1135 of the method 1100, the learned trajectory unit 1025 is arranged to predict a trajectory offset using a trained trajectory offset model. The learned trajectory unit 1025 is arranged to predict the offset 1230 between combined trajectory 1210 and the actual driver trajectory 1220 to provide an input to the trajectory blending unit 1030 indicative of a predicted trajectory offset. The learned trajectory unit 1025 comprises a trained trajectory offset model for determining the prediction of the trajectory offset 1230. The trajectory offset model is representative of the an offset between driver's actual trajectories and those autonomous trajectories from the trajectory planning unit 1040.

The learned trajectory unit 1025 may comprise a network, such as a neural network or artificial neural network (ANN), which is trained to estimate the trajectory offset. The learned trajectory unit 1025 comprises a trajectory offset model. The trajectory offset model may be pre-trained, i.e. prior to first utilisation of the system 1000, to determine the trajectory offset. In this way, when first used based upon ‘real’ input data, the trajectory offset model is able to predict the trajectory offset more accurately. In use, the trajectory offset model is updated based on actual trajectory offset data 1024 i.e. data relating to historic or experienced trajectory offsets, such that the trajectory offset model accuracy may improve. In some embodiments, each time driver override occurs, a new set of trajectory offset data is obtained upon which the trajectory offset model may be updated or trained, such as in a supervised learning process. In this way, over time, the trajectory offset model of the learned trajectory unit 1025 becomes more representative of the actual driver's trajectories and their offsets from the autonomous trajectory. Furthermore, in some embodiments, using driver identification the trajectory offset model may be personalised to a particular driver, or each of a plurality of drivers, to better represent each driver's trajectories. The driver identification may be achieved through recognition of an electronic device associated with the driver, such as a key fob or mobile telephone for example, or via recognition of one or more biometric attributes such as fingerprint, DNA, or facial features of the driver. Thus, in some embodiments, the learned trajectory unit 1025 may be provided with data identifying the driver. The learned trajectory unit 1025 is arranged to receive the trajectory offset data 1024 output by the trajectory offset determiner 1023, which is based on a difference between the combined trajectory determined by the trajectory blending unit 1030 and the actual driver trajectory 1022. The learned trajectory unit is arranged to output data indicative of a difference between the trajectory from the planner (which may differ from the combined trajectory) and the actual trajectory.

In block 1130 of the method 1100 the combined or blended trajectory for the vehicle 100 is determined by the trajectory blending unit 1030. The combined trajectory 1210 may be determined in dependence on the autonomous trajectory data 1045 and an output of the trajectory learning unit 1025. The trajectory blending unit 1030 is arranged to output 1035 an indication of the combined trajectory, as explained below. The combined trajectory is determined as described above with reference to the embodiment of FIGS. 5 and 6.

Advantageously the system formed by the driver trajectory determiner 1021, trajectory offset determiner 1023, learned trajectory unit 1025 in particular is arranged to compare the calculated combined trajectory from the trajectory blending unit 1030 with the actual driver trajectory 1220 each time the driver is in control i.e. has over-ridden the autonomous control of the vehicle 100. The learned trajectory unit 1025 is arranged to learn the driver's preferred trajectories and to output a correction to be applied to the autonomous trajectory from the trajectory planning unit 1040 in this embodiment. In this way, particularly when the learned trajectory unit 1025 is arranged to associate the offsets 1230 with a driver's identity, such as for each of a plurality of different possible drivers of the vehicle 100, the trajectory offsets 1230 are adapted for, or unique to, the particular driver of the vehicle 100.

The autonomous trajectory, such as determined by the trajectory planning unit 1040, is determined in order to minimise one or more parameters of KPIs, such as yaw rate, a lateral acceleration, and jerk of the vehicle 100. These parameters may, for example, have been determined by a manufacturer of the vehicle 100. As such they may not be appropriate or optimal for each particular driver of the vehicle 100, or one or more use cases of the vehicle 100 such as particular terrain over which the vehicle 100 will travel. By learning a personalised trajectory offset for the current driver a personalised trajectory may be provided, where the trajectory is a combination of both the learning and the autonomous trajectory. A final determined trajectory is able to learn, with experience i.e. supervised learning, how to behave in unusual scenarios (edge cases) not covered in a design of the autonomous trajectory planner.

In some embodiments, the autonomous trajectory, such as from the trajectory planning unit 1040, is associated with a collision free boundary defining a driveable space around the autonomous trajectory. In some embodiments, the system 1000 may be arranged to check that the determined combined trajectory falls within the boundary or driveable space. If this condition is not satisfied, the system 1000 may revert to using the determined autonomous trajectory.

In block 1140 of the method, the trajectory blending unit 1030 determines an error input 1035 for the steering controller 310. The error input 1035 for the steering controller 310 is determined in dependence on the autonomous trajectory 1045 and the predicted trajectory offset 1026 provided to the trajectory blending unit 1030. In the illustrated embodiment the error input 1035 is determined in dependence on the combined trajectory. The error input 1035 is determined by the trajectory blending unit 1030 between an actual or current trajectory of the vehicle 100 and the combined trajectory. An output of the trajectory blending unit 1030 may be error data 1035 indicative of the error between the current trajectory and the combined trajectory. For example, the error data 1035 may indicate an error in a lateral position and heading of the vehicle 100.

In block 1150 of the method 1100, the steering controller 1050 is arranged to determine the control input 1055 for the steering actuator 310 in dependence on the received error input 1035. The steering controller 1050 may determine the control input 1055 comprising the requested angle of the steering wheels 110 of the vehicle 100 as discussed above i.e. the RWA. The control input 1055 may comprise an indication of the torque to be applied by the steering actuator 310 to the steering system 300 to achieve the requested angle of the steering wheels 110. Data indicative of the control input 1055 for the steering actuator 310 is output from the steering controller 1050 in block 1150 of the method 1100. Block 1150 may comprise filtering or limiting a rate of change of the control input 1055.

In some embodiments, the control system 1000 comprises a filter or rate limiter 1060. The filter 1060, as described above, is for applying filtering to, or limiting a rate of change of, the control input 1055. The filter 1060 may be arranged to filter or limit the rate of change of one or both of the requested angle of the steering wheels 110 and the applied torque value. In this way, abrupt changes in the steering angle and/or applied torque may be reduced or avoided. The filter 1060 is arranged to receive the control data 1055 from the steering controller 1050 and to output filtered control data 1065 to the arbitrator 1080. The filter 1060 may receive the driver-in-control 1016 input from the driver actuation manager 1010 which may be used to activate or reset the filter 1060 when the driver is in control of the vehicle 100.

In block 1160 of the method 1100, the limit determiner 1070 is arranged to determine one or more limits for a magnitude of the control input to the steering actuator 310. In particular, the one or more limits may comprise at least one limit of a magnitude of the force applied by the steering actuator 310. In some embodiments, the one or more limits comprise one or more torque magnitude limits for the steering actuator 310. The one or more limits may comprise a maximum and a minimum torque limit in some embodiments. For example, the positive and negative torque limits may relate to opposing directions of movement of the steering control 200, such as anti-clockwise and clockwise rotation of the steering control 200 where the negative torque limit relates to a first direction of movement and the positive torque limit relates to a second direction of movement, as discussed above.

The limit determiner 1070 is arranged to determine the one or more limits in dependence on one or more parameters 1017 associated with the vehicle 100. The one or more limits act to limit a force to be applied by the steering actuator 310 to the steering system 300 of the vehicle 100. In particular, the one or more limits may limit the force to be applied by the steering actuator 310 which is perceived by the driver at the steering wheel 200 of the vehicle 100. In this way, a perception by the driver of steering force from the autonomous control of the vehicle 100 is controlled.

The limit determiner 1070 is arranged to receive vehicle data 1017 indicative of the one or more parameters 1017 associated with the vehicle 100. The one or more parameters associated with the vehicle 100 may comprise one or more of a speed, a yaw rate, a lateral acceleration, and jerk of the vehicle 100. The vehicle data 517 may be obtained from a communication bus of the vehicle 100 as will be appreciated. In the illustrated embodiment, the one or more parameters are obtained from the driver actuation manager 1010. In some embodiments, the one or more parameters comprise a time horizon for determining the control input for the vehicle 100.

In block 1170 of the method 1100, the arbitrator 1080 is arranged to arbitrate the control data 1065 in dependence upon the limit data 1075. That is, the arbitrator 1080 performs arbitration of the control input 1065 for the steering actuator 310 in dependence on the one or more limits determined by the limit determiner 1070. The control input 1065 may be controlled according to the one or more limits, such as the maximum and minimum torque limits. For example, torque value to be output by the steering actuator 310, as indicated in the control input 1065, may be controlled by the arbitrator 1080 to be less than the maximum torque limit and/or above the minimum torque limit. The indicated torque value may be capped at the maximum torque value and above the minimum torque value. As discussed above, when, for example, the maximum torque value decreases over time during a hander from autonomous to driver control, the torque applied to the steering wheel 200 which is perceived by the driver in contact with the steering wheel 200 reduces accordingly thereby giving the driver an experience of a comfortable transition whilst taking control of the vehicle 100. Similarly, during a transition from driver to autonomous control the torque gradually increases which gives the driver a reassuring experience of the autonomous control taking over.

In block 1180 of the method 1100 the arbitrator 1080 is arranged to output a signal 1085 indicative of the control input 1085 for the steering actuator 310 of the vehicle 100. The signal comprises arbitrated control data 1085 which may be indicative of the force to be applied by the steering actuator 310, such as the torque value to be applied to the steering system 300 and steering wheel 200 of the vehicle 100.

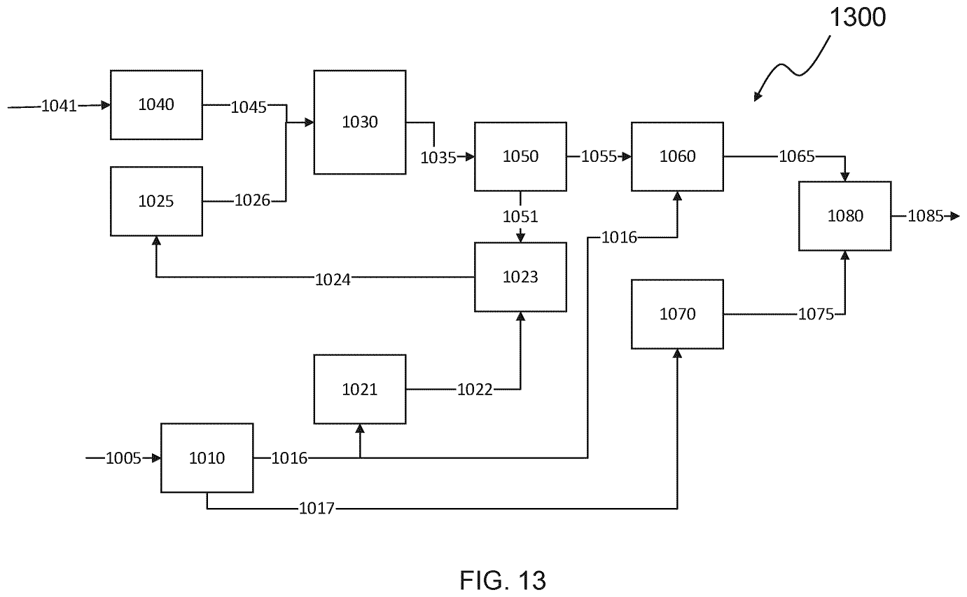

FIG. 13 illustrates a further embodiment of control system 1300, based on that shown in FIG. 10. The reader is directed to the description above in connection with FIGS. 10 and 11 unless otherwise described. In the embodiment illustrated in FIG. 13 the trajectory offset determiner 1023 is arranged to receive an output 1051 from the steering controller 1050, rather than the trajectory blending unit 1030 as shown in connection with the embodiment in FIG. 10. Using an output of the steering controller 1050 may allow for improved integration with existing architectures, particularly where an architecture has a separation between trajectory planning and control modules. For example, where the steering controller 1050 uses a model predictive control (MPC) scheme, the aim of the offset determiner 1023 is to modify the output of the steering controller 1050 based on a trajectory offset when the driver assumes control of the vehicle 100. The output 1051 of the steering controller 1050 is control data indicative of one or more control actions up to the time horizon of the controller. The control actions may comprise one or both of a predicted road wheel angle (RWA) and longitudinal acceleration of the vehicle 100. In some embodiments, the control actions may be determined at a time a driver override occurred or was detected. The offset determiner 1023 is arranged to receive the control data 1051 output by the steering controller 1050 and to determine an estimated trajectory that the vehicle 100 would achieve in dependence on the received control data 1051. The offset determiner 1023 is arranged to compare the estimated trajectory with that followed by the driver in control of the vehicle 100 to determine the trajectory offset.

As can be appreciated embodiments of the present invention improve a transition between at least partly autonomous control and driver control of a vehicle, particularly through determining a combined trajectory and controlling a torque applied to a steering system of the vehicle which is perceptible though the steering control 200 of the vehicle 100.

It will be appreciated that various changes and modifications can be made to the present invention without departing from the scope of the present application.

1. A control system for controlling a steering actuator of a vehicle, the control system comprising one or more controllers, the control system comprising:
input means for receiving:
a driver control signal indicative of a driver steering input at a steering control of the vehicle; and
autonomous trajectory data indicative of an autonomous trajectory for the vehicle;
processing means arranged to:
determine, in dependence on the driver control signal, a change in driving state of the vehicle and, when the change in driving state occurs, to:
determine, in dependence on the driver control signal, a driver trajectory for the vehicle;
determine an error input to a steering controller in dependence on the autonomous trajectory and the driver trajectory;
determine a control input for the steering actuator of the vehicle in dependence on the error input; and
determine one or more limits for a magnitude of the control input for the steering actuator in dependence on one or more parameters associated with the vehicle, to limit a force applied to the steering control; and
output means for outputting a signal indicative of the control input for the steering actuator of the vehicle.

2. The control system according to claim 1, wherein determining the driver trajectory for the vehicle comprises:
receiving environment data indicative of an environment of the vehicle; and
predicting the driver trajectory in dependence on the environment data and the driver control signal.

3. The control system according to claim 2, wherein the predicting is performed using a trained driver trajectory model.

4. The control system according to claim 2, comprising determining a combined trajectory in dependence on the autonomous trajectory and the predicted driver trajectory.

5. The control system according to claim 1, wherein determining the driver trajectory for the vehicle comprises:
determining an actual driver trajectory for the vehicle in dependence on the driver control signal; and
determining a trajectory offset in dependence on the actual driver trajectory in dependence, at least in part, on the autonomous trajectory.

6. The control system according to claim 5, wherein determining the trajectory offset comprises:
determining a predicted trajectory offset using a trained trajectory offset model; and
determining a combined trajectory in dependence on the autonomous trajectory and the predicted trajectory offset.

7. The control system according to claim 6, comprising determining the trajectory offset between the combined trajectory and the actual driver trajectory.

8. The control system according to claim 6, comprising determining the trajectory offset between the control input for the steering actuator of the vehicle and a corresponding input associated with the actual driver trajectory.

9. The control system according to claim 1, wherein the error input to the steering controller is determined in dependence on one or more parameters associated with the autonomous trajectory and the driver trajectory.

10. The control system according to claim 1, wherein the one or more parameters associated with the vehicle on which the one or more limits for the magnitude of the control input are determined comprise one or more of a speed, a yaw rate, a lateral acceleration, and jerk of the vehicle.

11. The control system according to claim 1, wherein the steering control of the vehicle is a steering wheel.

12. A system, comprising:
the control system according to claim 1; and
an actuator responsive to the signal indicative of the control input for the vehicle.

13. A vehicle comprising the control system according to claim 1.

14. A method, comprising:
receiving a driver control signal indicative of a driver input at a control of a vehicle;
receiving autonomous trajectory data indicative of an autonomous trajectory for the vehicle;
determining, in dependence on the driver control signal, a change in driving state of the vehicle;
determining, in dependence on the driver control signal, a driver trajectory for the vehicle;
determining an error input to a controller for determining a control input for the vehicle in dependence on the autonomous trajectory and the driver trajectory;
determining one or more limits for a magnitude of the control input at the control in dependence on one or more parameters associated with the vehicle; and
outputting a signal indicative of the control input for the vehicle to control an actuator associated with the control.

15. A computer readable medium storing instructions which, when executed by a computer, are arranged to cause the computer to perform the method according to claim 14.
